(19) United States
(12) Patent Application Publication
(10) Pub. No.: US 2005/0107103 A1
(43) Pub. Date: May 19, 2005

(54) Wireless communications arrangements with synchronized packet transmissions

(76) Inventor: Diego Melpignano, Monza (IT)

Correspondence Address: PHILIPS INTELLECTUAL PROPERTY & STANDARDS, P.O. BOX 3001, BRIARCLIFF MANOR, NY, 10510, US

(21) Appl. No.: 10/504,751

(22) PCT Filed: Jan. 29, 2003
(86) PCT No.: PCT/IB03/00279

(30) Foreign Application Priority Data
Feb. 20, 2002 (EP) 02075689.6

(51) Int. Cl. H04B 7/005

(52) U.S. Cl. 455/502

(57) ABSTRACT

A wireless, e.g. radio communications arrangement is disclosed, which includes an access point (12) in which are integrated a plurality of radio modules (20). Each module (20) is configurable as a master unit of an area network (10) and comprises its own native clock (28) for clocking said module (20) independently of the native clock (28) of any other said module (20). Each said module (20) further comprises its own baseband controller (24) and radio transceiver (26) and is adapted for wireless communication with one or more mobile terminals (16) by transmission of packets a,c in timeslots defined by said native clock (28) of said module (20). Each said module (20) further comprises at least one external input (18, 180; 30), through which in use is supplied a signal which substantially synchronizes said modules (20) in such a manner that there is no partial collision between packets transmissions of two said modules (20) integrated into the same said access point (12).

The present invention relates to wireless communications arrangements and in particular to a wireless communications arrangement in which a group of wireless communications modules are integrated into a single communications device, such as an access point to an area network.

Wireless communications systems based on radio units and connections used to group them at least temporarily into a shared resource network are known. One current implementation of this general type is in the form of a short-range, frequency-hopping and uncoordinated network and is known in the art as “Bluetooth” (™) communications. This arrangement is controlled by the Bluetooth standard and a full specification for conformity in Bluetooth communications can be found through the Bluetooth Special Interests Group (SIG), whose web site can be found at “www.bluetooth.com” along with the current Bluetooth standard and related information.

A useful discussion of Bluetooth communications can be found in text book form in “Bluetooth, Connect Without Wires” by Jennifer Bray and Charles F. Sturman, published by Prentice Hall PTR under ISBN 0-13-089840-6.

Further prior art can be found in, for example, WO 01/20940, US5940431 and in US published applications 2001/0005368A1 and 2001/0033601A1, in which some aspects of the current state of the art in this field are also discussed.

The reader is referred to the above mentioned sources for general Bluetooth background information and also, for example, for clarification of terms of art used herein and not specifically defined below.

There are two main states that a Bluetooth module/device can be in, referred to in the art as “Standby” and “Connection”. The standby state is the default state in which a Bluetooth device has no links with other devices. In order to establish a link with another Bluetooth device and achieve the connected state, two procedures must be executed sequentially and these are referred to as “Inquiry” and “Page”.

Any device may issue an inquiry message and the inquiry phase is used to obtain the address of a potential master or slave unit, the address being referred to as the Device Access Code (DAC). The inquiry procedure does not establish a connection between devices, only the page procedure can do this. The inquiry procedure identifies potential candidates for connection and gathers their addresses. Once a device knows the DAC of a further device, obtained by for example the inquiry procedure, it can page that device. If the paging is successful, the pager and the paged device will enter into the connected state, in which they interact exchanging data packets.

When an access point in some prior art arrangements is required to perform the inquiry and paging operations in sequence, there can be inconvenient delays before connections are made. This is especially so in cases where an access point receives multiple responses to the transmission of inquiry messages or if it receives multiple requests for handoff from already connected slave units. In addition, the same radio module which performs all these functions must also be shared within the or each access point for interaction with the or each slave unit in its piconet. It is therefore desirable to look for arrangements in which speed of response and capacity might be improved over certain of the prior art proposals.

As the cost of radio communications modules decreases, the temptation to integrate multiple modules in to a single communications device becomes appealing, so as to increase the overall capacity of the system. One example of such an application would be to integrate several modules into a single access point of a network which is capable of supporting Bluetooth communications. The free running nature of the Bluetooth clock, however, implies that there may be interference between the uncoordinated frequency hopping patterns of such multiple integrated modules.

It is an object of the present invention to provide an improved wireless communications arrangement and, in particular, an improved wireless communications arrangement including a group of wireless communications modules integrated into one communications device.

Accordingly, the present invention provides a communications device including a group of wireless communication modules integrated therein, each of which wireless communications modules is configurable as a master unit of a shared resources network, e.g. a LAN, and comprises its own native clock for clocking said wireless communications module independently of the native clock of any other wireless communications module in said group, each said module further comprising its own baseband controller and a transceiver and being adapted for wireless communication with one or more user terminals, e.g. mobile or fixed terminals, by transmission of packets in timeslots defined by said native clock of said module, each said module further comprising at least one external input through which in use is supplied a signal which is used to substantially synchronize said modules in such a manner that packet transmissions of two said modules integrated into the same said communications device are synchronized. Preferably, there is no or reduced partial collision between packet transmissions of two said modules integrated into the same said communications device.

Said wireless communications modules may be synchronized by synchronization of their native clocks. Said synchronization may be achieved by each said baseband controller writing substantially simultaneously the same pre-assigned value into a native clock register of its respective said module. Said baseband controller may be prompted through a said external input to write said pre-assigned value, preferably on initialization of said device.

A said external input may comprise an interrupt line operative to synchronize said modules, for example by application of an initialization, reset or interrupt signal common to each said module.

Said wireless communications modules may be synchronized by use therebetween of a common oscillator, supplied to each said module through for example a said external input.

Said synchronization may substantially align said timeslots between a plurality of said modules and preferably aligns boundaries or borders of said timeslots.

Said synchronization may ensure that each said packet transmission is either successfully transmitted or substantially completely destroyed by a further packet transmission from another said wireless module of said device.

Said device may further comprise a host processor adapted to control access from said device to said shared resources network. A plurality of said wireless communications modules may be connected to said shared resources network through said host processor. One or more of said wireless communications modules may be connected to said host processor via a Host Controller Interface (HCI).

At least two said wireless communications modules may devoted to different communications tasks and one said module may be devoted solely to the capture of user terminals which are in range of said device but which are not currently connected thereto.

Said device may comprise an access point of a local wireless area network and said local area network may preferably comprise a frequency hopping communications network operating, for example, in accordance with the Bluetooth protocol. However, the present invention is not limited thereto and may include diffuse infra-red as a transmission medium.

The present invention also provides a method of operating a wireless communications device which includes a group of wireless communications modules integrated therein, the method including:
a) configuring each said wireless communications module as a master unit of a shared resources network;
b) clocking each said wireless communications module independently of any other said wireless communications module in said group by using a respective native clock for each said wireless communications module;
c) engaging in wireless communication with one or more user terminals by one or more of said wireless communications modules transmitting packets in timeslots defined by said native clocks; and
d) substantially aligning said timeslots between said wireless communications modules.
   Preferably, said method ensures that there is no or reduced partial collision between packet transmissions of two said wireless communications modules integrated into the same said radio communications device.

The method may include synchronizing said wireless communications modules by synchronization of their native clocks. Each said wireless communications module may include a baseband controller and said synchronization may be achieved by said baseband controller writing substantially simultaneously the same pre-assigned value into a native clock register of its respective said wireless communications module. The method may include prompting said baseband controller, through an external input, to write said pre-assigned value, preferably on initializing said device. Said external input may comprise an interrupt line operative for synchronizing said modules, for example by applying an initialization, reset or interrupt signal commonly and substantially simultaneously to each said module.

The method may include synchronizing said wireless communications modules by using therebetween a common oscillator, supplying said oscillator to each said wireless communications module through, for example, an external input.

The method may include synchronizing said wireless communications modules by substantially aligning said timeslots between a plurality of said wireless communications modules and preferably by aligning boundaries or borders of said timeslots.

The method may include ensuring through said synchronization that packet transmissions are either successfully transmitted or completely destroyed by a further packet transmission from another said wireless communications module of said device.

The method may include connecting a plurality of said wireless communications modules to said shared resources network through a host processor and may include connecting one or more of said wireless communications modules to said host processor via a host controller interface.

The method may include devoting at least two said modules to different communications tasks and may include, for example, devoting one said wireless communications module solely to the capture of user terminals which are in range of said device but which are not currently connected thereto.

The method may include using said device as an access point of a local wireless area network, said wireless area network preferably comprising a frequency hopping communications network operating, for example, in accordance with the Bluetooth protocol.

The present invention also provides a communications network comprising at least one a communications device in accordance with the communications device of the invention or comprising a communications device operative in accordance with the method of the invention, said device preferably being configured as an access point of said network.

The present invention will now be described by way of example only and with reference to the accompanying drawings, in which:

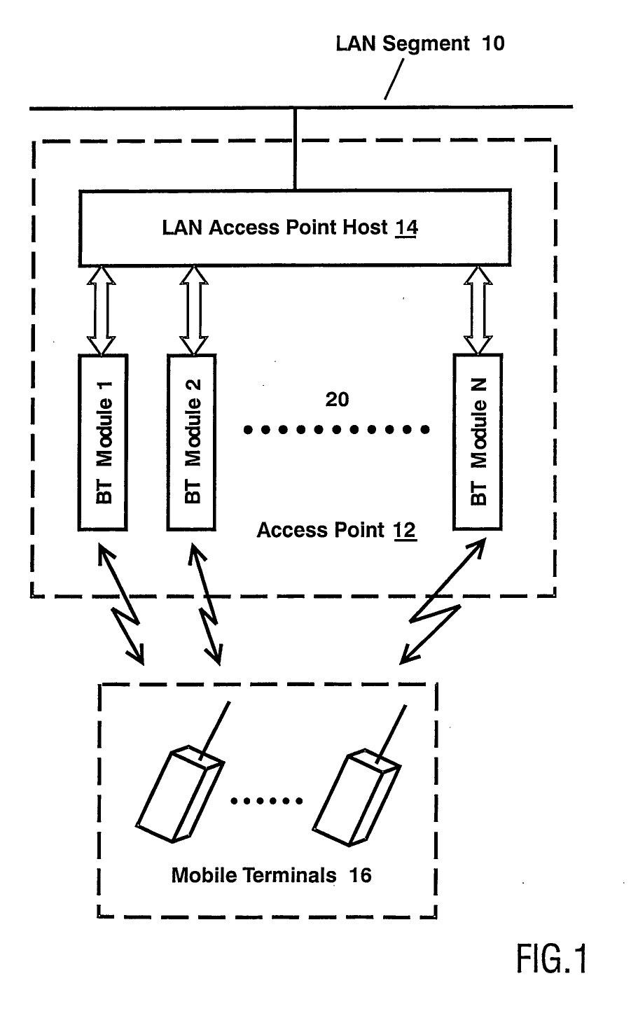

FIG. 1 is a schematic diagram of the basic architecture of an access point which includes multiple radio modules;

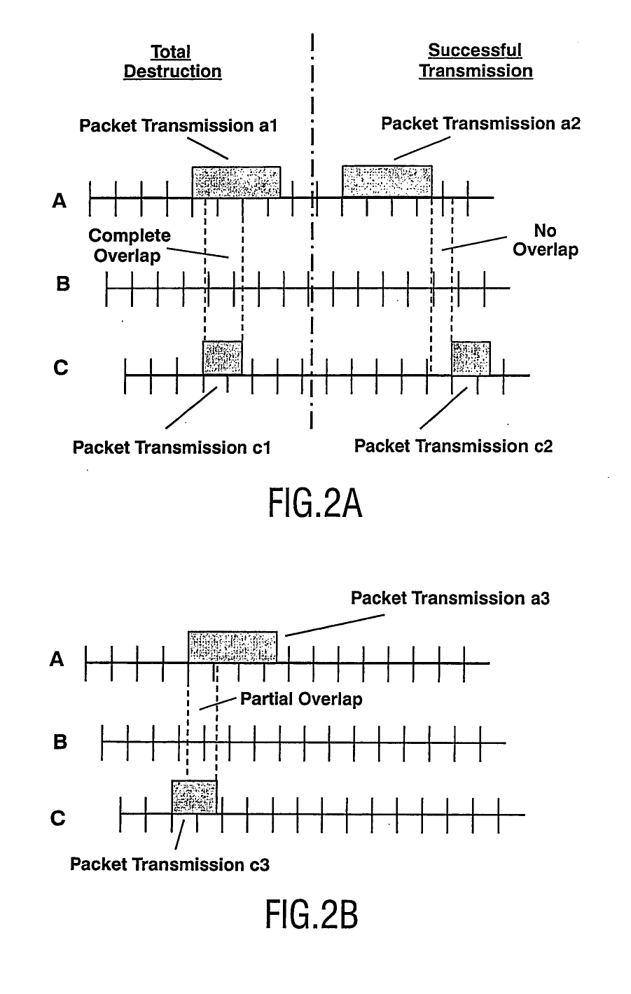

FIGS. 2A and 2B represent instances of time slot utilization of a basic arrangement according to FIG. 1;

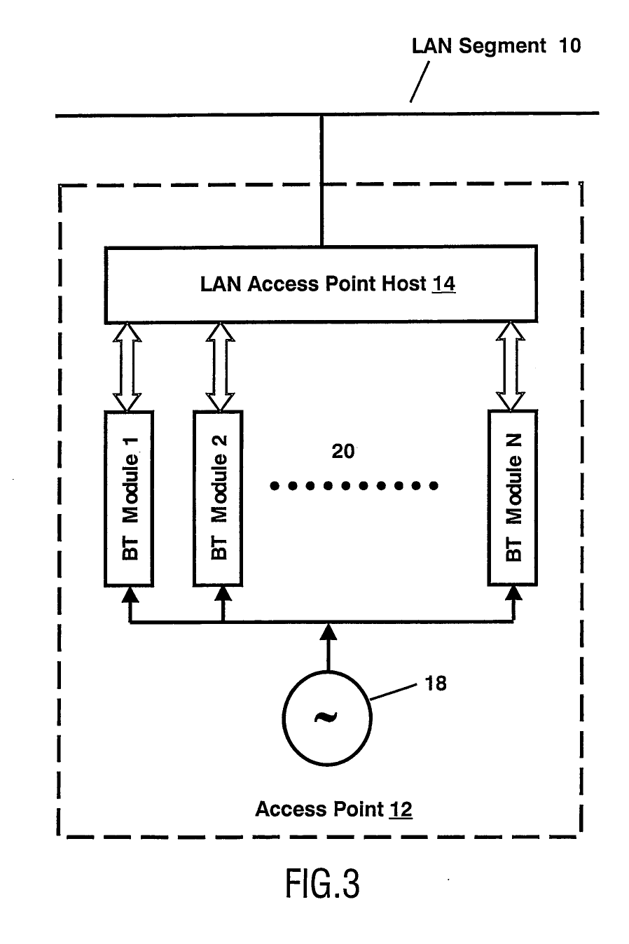

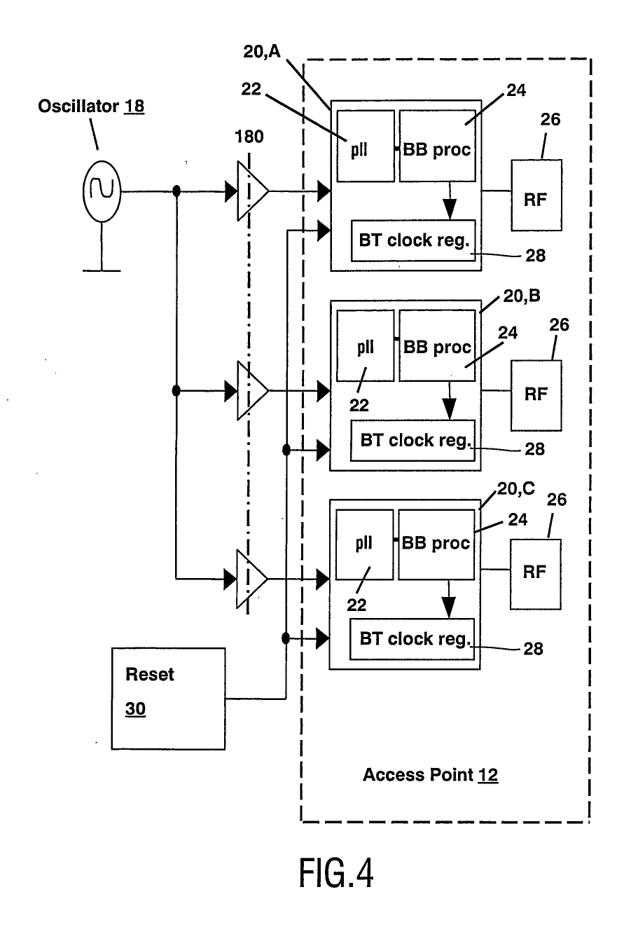

FIGS. 3 and 4 are schematic diagrams of the basic arrangement according to FIG. 1 incorporating a modification in accordance with an embodiment of the present invention; and

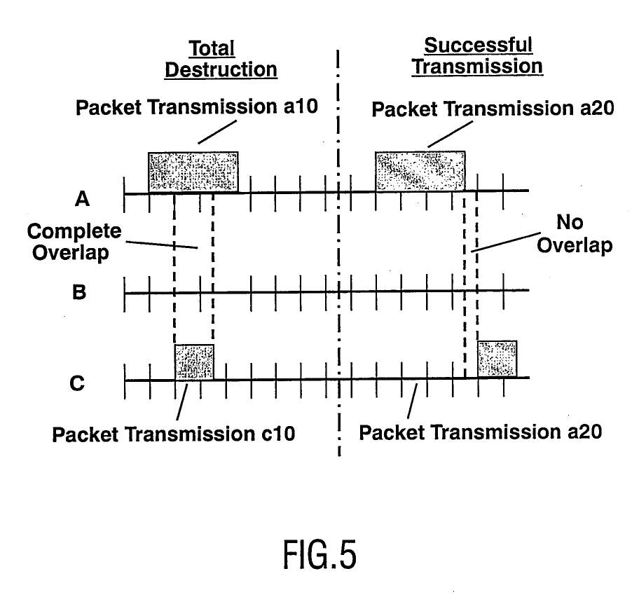

FIG. 5 represents timeslot utilization of the arrangement according to FIGS. 3 and 4.

The present invention will be described with reference to certain embodiments and drawings but the present invention is not limited thereto but only by the attached claims. Further, the present invention will be described mainly with reference to a local area network but is not limited thereto. The network may be any form of shared resource network (SRN), i.e. in an SRN hardware resources are shared, and each hardware network element can be accessed from any other network element. An SRN in accordance with the present invention is more-or-less synonymous with a CAN, LAN or WAN, but the term SRN will be used to indicate that the present invention is not limited to specific aspects of known CANs, WANs or LAN's e.g. contention scheme or whether Ethernet, Token Ring or Wireless LAN. In particular, the present invention relates to a PAN—a personal area network, involving short range radio connection between mobile units and master units. Also the topology of the PAN, LAN or WAN is not considered a limit on the present invention, e.g. bus physical, star physical, distributed star, ring physical, bus logical, ring logical may all be used as appropriate. Various standards have been produced for LAN's, e.g. IEEE 802.3, IEEE 802.4, IEEE 802.5, ANSI X3T9.5 (FDDI, I and II) any of which may find advantageous use with the present invention. LAN and WAN design and construction are discussed in detail in, for example, “Mastering Local Area Networks”, by Christa Anderson and Mark Minasi, SYBEX Network Press, 1999 or “Data Communications, Computer networks and Open Systems”, by Fred Halsall, Addison-Wiley, 1996. Various types of wireless LAN have been standardized or are in general use, e.g. the standards IEEE 802.11, IEEE 802.11 HR (Spread Spectrum)and systems based on DECT, Blue Tooth, HIPERLAN, Diffuse or point-to-point infra- red. Wireless LAN's are discussed in detail in “Wireless LAN's” by Jim Geier, Macmillan Technical Publishing, 1999. The term “wireless” includes in accordance with this invention any form of communication which does not require a physical connection such as a wire or wires, a coaxial cable, a fibreoptic cable. For instance the present invention includes the use of diffuse infra-red as a transmission medium.

All the embodiments of the present invention can include master and slave units which communicate in accordance with the Bluetooth protocol. The features of such a system may include one or more of:
Slow frequency hopping as spread spectrum technique; i.e. the hopping rate is slower than the modulation rate;
Master and slave units whereby the master unit can set the hopping sequence;
Each device has its own clock and its own address;
The hopping sequence of a master unit can be determined at least in part from its address;
A set of slave units communicating with one master all have the same hopping frequency (of the master) and form a piconet;
Piconets can be linked through common slave units to form a scatternet;
Time division multiplex transmissions between slave and master units;
Time Division Duplex transmissions between slaves and masters units;
Transmissions between slave and master units may be either synchronous or asynchronous;
Master units determine when slave units can transmit;
Slave units may only reply when addressed by a master unit;
The clocks are free-running;
Uncoordinated networks, especially those operating in the 2.4 GHz license-free ISM band;
A software stack to enable applications to find other Bluetooth devices in the area;
Other devices are found by a discovery/inquiry procedure; and
Hard hand-overs.

It is generally accepted that the term “slow frequency hopping” refers to the hopping frequency being slower than the modulation rate and that fast frequency hopping refers to a hopping rate faster than the modulation rate. The present invention is not limited to either slow or fast hopping. The present invention is also not limited to only the Bluetooth protocol but includes any suitable protocol for connection orientated (e.g. circuit switched) wireless arrangements which use a spread spectrum technique, such as for example frequency hopping, and lack a true broadcast, beacon or pilot channel. Some such arrangements may also be referred to as uncoordinated cellular systems in which each master unit plays the roll of a base station and a cell can be considered its coverage area.

Referring to the figures, a radio communications arrangement includes a shared resources network in the form of a shared resources network, such as a local area network (LAN) whose operation is not incompatible with a wireless communications network operating with the Bluetooth standard and protocol. The shared resources network may be any of the shared resources network mentioned above, for example, a wired LAN or a wireless LAN. Only a segment of the LAN 10 is shown, to which is connected a LAN access point 12. The access point 12 includes an access point host 14, which comprises a host processor (not shown separately).

The access point 12 is a wireless access point for providing access to mobile wireless or fixed wireless terminals 16 (only mobile terminals are shown but this is non-limiting). The access point 12 comprises a plurality of wireless communication modules, e.g. radio or diffuse infra-red modules. As an embodiment of the present invention a plurality (1,2 . . . N) of independent Bluetooth radio modules 20 are integrated into the same access point 12 and each of the radio modules 20 is connected to the LAN host 14 by means of distinct instances of a Host Controller Interface (HCI). The radio modules 20 communicate with the LAN 10 through the LAN host 14 and can form a local wireless area network (piconet) with mobile or fixed wireless terminals 16. The radio modules may be configured as Bluetooth master units adapted for wireless communication, using their own transceivers 26, with one or more mobile or fixed wireless terminals 16 which are configured as slave units 16 within this piconet. The radio communication between slave and master units may use a frequency hopping pattern in accordance with the Bluetooth standard. Each radio module 20 may be in the form of an integrated chipset 22, 24, 26, 28, each of which includes a programmable base band processor (BB proc) 24 which is associated with a phase-locked loop (pll) 22 and with the module's individual radio transceiver 26.

The radio modules 20 generate Piconets when they succeed in communicating with slave units 16. Each radio module 20 has its own native clock, represented by its Bluetooth (BT) clock register 28, and the frequency hopping patterns of the Piconets are determined by the module address and the native clock of their respective master unit (1,2 . . . N). It will be noted here that the definition of the Bluetooth native clock 28 in a module 20 may be “the value of a 24-bit counter fed by a free running oscillator” or similar and this clock determines the timeslots for its radio module 20. In the basic arrangement of FIG. 1, each radio module 20 has its own oscillator and its own 24-bit counter 28 and these run completely independently of the clock in any other radio module 20.

Since the clocks of the radio modules 20 are all independent of each other, the slot timings of baseband packet transmissions for a single carrier frequency are unsynchronized and therefore their borders/boundaries can be expected to be usually substantially unaligned. This results in transmission timing which may be in accordance with, or similar in nature to, that shown with particular reference to FIGS. 2A and 2B. In the situation depicted, the transmission of packet data from three unsynchronized modules 20 is represented, these particular modules 20 being referred to for convenience out of the group (1, 2 . . . N) as modules A, B, C. Only modules A and C are considered to be transmitting packets in this instant scenario.

It will be noted in FIGS. 2A and 2B that interference among the uncoordinated frequency hopping patterns of unsynchronized modules A, B, C may reduce overall performance and may result, for example, in no collision or complete collisions (FIG. 2A) or in partial collisions (FIG. 2B). The collisions may occur between potentially overlapping packet data a1, c1; a2, c2; a3, c3 being transmitted in one or more time-slots by different radio modules A, C in the group A, B, C integrated into the same access point 12.

In a complete collision, one packet transmission al will totally destroy the overlapped packet transmission cl whereas, with no overlap, both packet transmissions a2, c2 are transmitted'successfully. These situations are represented in the left and right hand portions respectively of FIG. 2A.

In a partial collision, a partial overlap exists between the packet transmission a3 from one module A and the packet transmission c3 of another module C. Under these circumstances, data packets a3, c3 may be partially or completely lost and such a situation is represented in FIG. 2B. In the event of a partial overlap, the effect may be determined in accordance with a contention scheme, e.g. in a similar fashion to that experienced in ALOHA and slotted-ALOHA. A partial time overlap in the transmission of packets at the same frequency can result in bit errors which may not be able to be corrected by the receivers and consequently retransmissions will be requested. This causes a loss of capacity. As the retransmission requests are added to existing transmissions the effect on capacity can be severe. In fact, as the retransmissions plus existing transmissions are an even higher system loading, more collisions can be expected which will result in yet more retransmissions (e.g. retransmission of retransmission, etc.). The result can be a catastrophic failure of the system known as “blocking”.

Referring now in particular to FIGS. 3 and 4, the basic arrangement of FIG. 1 has been modified by the use of a common oscillator 18 fed into each independent radio module 20; A, B, C through an external input line via a buffer 180. The modules 20; A, B, C also share a common reset 30, which is adapted to provide commonly, and preferably substantially simultaneously, to each said radio module external inputs such as interrupt, reset or initialization signals which may be used as prompts inside the radio module at for example the baseband processor 24. On powering up the access point 12, the phase-locked-loops 22 of the modules 20; A, B, C will need varying times to synchronize, but the use of the external oscillator 18 substantially guarantees that the native clocks 28 will not drift away in three chipsets 22, 24, 26, 28.

To guarantee that the Bluetooth timeslots are aligned between the modules 20; A, B, C as soon as possible, the native clock registers 28 of all the group A, B, C are preferably initialized substantially simultaneously. This may be achieved by firmware which is embedded in the baseband processors 24. For example, in this exemplary embodiment a dedicated interrupt line, “reset” 30, may be used for this purpose which is activated by external reset circuitry at power-up. The reset circuit 30 generates an interrupt signal after a predetermined delay, which ensures that the device initialization can progress. In response to a prompt, a related interrupt service routine in each baseband processor 24 then writes a pre-assigned value into its respective clock register 28, which is the same pre-assigned value for each of the modules A, B, C in the group. In this manner, the borders or boundaries of the timeslots are adequately aligned to significantly reduce the chances of at least partial overlaps between packet transmissions of two modules 20 integrated into the same access point 12.

The effects of synchronizing the native clocks 28 of all the modules 20 in the group (1,2 . . . N; A, B, C) integrated into a single access point 12, and the subsequent substantial alignment of the borders/boundaries of their time-slots, can be seen with particular reference to FIG. 5. In similar fashion to FIGS. 2A and 2B, only three modules 20 are taken by way of example A, B, C, of which only two A, C are considered for the moment to be transmitting packet data. The alignment of timeslots between all the modules A, B, C ensures that packet transmissions are either completely destroyed a10, c10 or successfully transmitted a20, c20 by a packet being transmitted at the same time by another module A, B, C. This situation is demonstrated by way of example in the left and right hand portions respectively of FIG. 5.

It can therefore be seen that synchronization of the clocks 28 between a group (1,2 . . . N; A, B, C) of master units 20 integrated into the same access point 12 ensures that the probability of partial collisions between packets a,c is substantially eliminated. This is true of the probability of both partial and full collisions, which might otherwise result in uncorrectable bit errors due to the fact that both radios might be transmitting on the same frequency at the same time. The probability of time collisions in the transmission of packets is halved and the gain in efficiency becomes ever more noticeable as the number of modules 20 integrated into any single access point 12 increases.

In the particular instance of Bluetooth communications, the integration of multiple modules 20 into a single access point 12 takes advantage of the currently reducing costs of off-the-shelf communications modules to increase the capacity of each access point 12 to support mobile terminals 16 and hence increase the overall capacity of the area network LAN 10. It is anticipated that similar advantages could accrue to equivalent arrangements without departing from the spirit of the present invention. Alignment of the borders/boundaries of the timeslots in which such integrated modules 20 transmit packets significantly increases the efficiency and practicality of such an arrangement by at least substantially reducing the chances of at least partial collisions between transmissions.

In a variation to the embodiment described above, the integration of multiple radio modules 20 into a single access point 12 enables the devotion of different modules 20; A, B, C to different tasks. For example, one of the integrated modules 20 may be devoted solely to the capture of mobile terminals 16 which are within range of the access point 12 but which are not currently connected to it.

While the present invention has been particularly shown and described with respect to a preferred embodiment, it will be understood by those skilled in the art that changes in form and detail may be made without departing from the scope and spirit of the invention. For example, it will be noted that connection of the modules (1,2 . . . N) to the LAN 10 through the host 14 is optional.

1. A communications device including a group of wireless communications modules integrated therein, each of which wireless communications modules is configurable as a master unit in a shared resources network and comprises its own native clock for clocking said wireless communications module independently of the native clock of any other said module, each said wireless communications module further comprising its own baseband controller and a transceiver and being adapted for wireless communication with one or more user terminals by transmission of packets in timeslots defined by said native clock of said radio module, each said wireless communications module further comprising at least one external input through which in use is supplied a signal which is used to substantially synchronize said modules in such a manner that packets transmissions from two said wireless communications modules integrated into the same said communications device are synchronized.

2. A device according to claim 1, wherein said wireless communications modules are synchronized by synchronization of their native clocks.

3. A device according to claim 1 or claim 2, wherein said synchronization is achieved by each said baseband controller writing substantially simultaneously the same pre-assigned value into a native clock register of its respective said wireless communications module.

4. A device according to claim 3, wherein said baseband controller is prompted through a said external input to write said pre-assigned value, preferably on initialization of said device.

5. A device according to any preceding claim, wherein a said external input comprises an interrupt line operative to synchronize said wireless communications modules, for example by application of an initialization, reset or interrupt signal common to each said wireless communications module.

6. A device according to any preceding claim, wherein said wireless communications modules are synchronized by use therebetween of a common oscillator, supplied to each said wireless communications module through for example a said external input.

7. A device according to any preceding claim, wherein said synchronization substantially aligns said timeslots between a plurality of said wireless communications modules and preferably aligns boundaries or borders of said timeslots.

8. A device according to any preceding claim, wherein said synchronization ensures that each said packet transmission is either successfully transmitted or substantially completely destroyed by a further packet transmission from another said wireless communications module of said device.

9. A device according to any preceding claim, further comprising a host processor adapted to control access from said device to said shared resources network.

10. A device according to claim 9, wherein a plurality of said wireless communications modules are connected to said shared resources network through said host processor.

11. A device according to claim 9 or claim 10, wherein one or more of said wireless communications modules are connected to said host processor via a Host Controller Interface (HCI).

12. A device according to any preceding claim, wherein at least two said wireless communications modules are devoted to different communications tasks.

13. A device according to claim 12, wherein one said wireless communications module is devoted solely to the capture of user terminals which are in range of said device but which are not currently connected thereto.

14. A device according to any preceding claim, said device comprising an access point of a wireless area network and said wireless area network preferably comprising a frequency hopping communications network operating, for example, in accordance with the Bluetooth protocol.

15. A method of operating a radio communications device which includes a group of wireless communications modules integrated therein, the method including:
a) configuring each said wireless communications module as a master unit of a shared resources network;
b) clocking each said wireless communications module independently of any other said wireless communications module in said group by using a respective native clock for each said wireless communications module;
c) engaging in wireless communication with one or more user terminals by one or more of said wireless communications modules transmitting packets in timeslots defined by said native clocks; and
d) substantially aligning said timeslots between said wireless communications modules.

16. The method according to claim 15, whereby said method ensures that there is no or reduced partial collision between packet transmissions of two said radio modules integrated into the same said communications device.

17. A communications network comprising at least one a communications device in accordance with any one of claims 1 to 14 or operative in accordance with the method of claim 15, said device preferably being configured as an access point of said communications network.
